(19) United States
(12) Patent Application Publication
(10) Pub. No.: US 2017/0212055 A1
(43) Pub. Date: Jul. 27, 2017

(54) METHOD FOR OPTICAL MEASUREMENTS OF MULTIPLE PHOTOCHEMICAL SENSORS

(71) Applicant: Osmo Systems, Inc., Berkeley, CA (US)

(72) Inventors: Zachary Stein, Berkeley, CA (US); James Regulinski, Daly City, CA (US); Paul Holowko, San Jose, CA (US)

(21) Appl. No.: 15/412,475

(22) Filed: Jan. 23, 2017

Related U.S. Application Data
(60) Provisional application No. 62/281,590, filed on Jan. 21, 2016.

(51) Int. Cl. G01N 21/77; G01N 21/85

(52) U.S. Cl. CPC G01N 21/77; G01N 21/8507

(57) ABSTRACT

The disclosure describes various embodiments that utilize optical sensor to characterize attributes of a liquid. Some sensor configuration continue to function properly even after scaling begins to reduce the visibility of photochemical sensors that measure the attributes of the liquid. This allows significantly longer continuous operating periods and lower maintenance costs.

### CROSS-REFERENCES TO RELATED APPLICATIONS

This present application claims priority to U.S. Provisional Application No. 62/281,590, filed Jan. 21, 2016, the entire contents of which is incorporated by reference herein in its entirety and for all purposes.

### BACKGROUND OF THE INVENTION

A number of products using optical sensors have been used to measure liquid parameters of an aquarium. The problems with these existing optical sensors are: they can only read a limited number of photochemical sensors per device, they cannot be easily incorporated into existing plumbing systems, but must be placed into a tank of water; and the only way to address bio-fouling, a common problem in optical sensors, is for the user to manually clean the device. For this reason a better liquid characterization system is desirable.

### SUMMARY OF THE INVENTION

This disclosure describes various embodiments that relate generally to ways of optically measuring properties of liquids. In particular, this disclosure describes a mechanical apparatus for taking optical measurements of multiple aqueous photochemical sensors.

The mechanical apparatus can be attached to an existing plumbing system or water can be pumped through it using a submersible pump. To take measurements, water flows over the photochemical sensor patches inside the apparatus. These are placed and secured onto a clear slide which acts as a window into the apparatus and the sensors react depending upon the water content. Beneath the slide is a light-guiding panel that allows light from a light source below to shine up a vertical hole onto a photochemical sensor. The returning light travels down an angled hole onto a light reading device, measuring the photochemical sensors' color, light intensity, and/or duration. This device then delivers this raw light data to the unit's CPU. The apparatus also includes a “white-balance” sequence that is able to mitigate the effects of bio-fouling, a common problem with optical sensors in aqueous solutions.

In this way, the described invention is able to take continuous measurements of numerous parameters in aqueous solutions over-time. Such parameters could include, but are not limited to: pH, dissolved oxygen, ammonia (NH₃), nitrate, nitrite, phosphorous, and potassium.

The light reading devices rely on shining lights onto photochemical sensor patches and measuring the returning color, duration, or intensity of light. If you imagine a litmus dip-stick often used for taking manual readings of pH in aquariums, pools, and Jacuzzis, optical sensors work the same way, but replace the human eye reading the color, intensity, or duration of light with an electronic light receiver that can analyze these factors. Optical sensors are advantageous over conventional electronic sensors for continuous monitoring of aqueous solutions not only because they cost less up front, but they require less maintenance. While the active ingredients in the photochemical sensor patches do become less efficient overtime, they do not require recalibration. Because of their low-price point, these photochemical sensors can be disposable, requiring less time and money from the user compared with electrical sensors. In between replacements of these optical sensors, the user will only need to physically interact with optical sensors to clean them if substantial bio-fouling has occurred.

An optical measuring device is disclosed and includes the following: a housing defining a channel therethrough; photochemical sensors disposed along an interior surface of the housing that defines at least a portion of the channel; a calibration sensor disposed along the interior surface; a light emitting system configured to emit light at the photochemical sensors and the calibration sensor; and a light detecting system configured to measure the intensity of the light reflected off each of the plurality of photochemical sensors and the intensity of light reflected off the calibration sensor; and a processor configured to receive intensity measurements from the light detecting system, calibrate the intensity measurements associated with the plurality of photochemical sensors using the intensity measurements associated with the calibration sensor and determine one or more characteristics of aqueous solution flowing through the channel using the calibrated intensity measurements.

Another optical measuring device is disclosed and includes the following: a housing defining a cavity; a lid coupled to the housing and extending across an opening leading into the cavity, the lid defining a plurality of slits that are configured to allow water to flow between the housing and the lid; a photochemical sensor disposed within the cavity; a light emitter configured to emit light at the photochemical sensor; an optical sensor configured to measure the intensity of the light reflected off the photochemical sensor; and a processor configured to receive intensity measurements from the optical sensor of the light reflected off the photochemical sensor and determine one or more characteristics of aqueous solution flowing through the slits using the calibrated intensity measurements.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a flowchart indicating the steps used by the apparatus to take readings of the photochemical sensors;

FIG. 2 is a flowchart illustrating the steps used to “white balance” the return light and mitigate the darkening effects of bio-fouling in the tube;

FIG. 3 is a side angle, exploded view drawing of the apparatus and all of its components;

FIG. 4 is a lengthwise, cut through of the assembled invention;

FIG. 5 is a drawing of the underside of the invention;

FIG. 6 is an angled, cut-through drawing of the invention demonstrating how light travels through it;

FIG. 7 is another cut-through drawing of the invention demonstrating how light travels through it;

FIG. 8 is a drawing of another variation of the invention where light-guiding panel 4 is larger and can be incorporated as a part of the enclosure for the unit's electronic components;

FIG. 9 is a drawing of a third variation of the invention where the apparatus is potted in a water proof material and built into a submersible probe. This drawing is an expanded view of such a probe;

FIG. 10 is a drawing of the submersible probe in its assembled form.

FIG. 11 is an exploded view of the submersible probe that also demonstrates its ability to “white balance” the sensor readings

FIG. 12 is an angled, cut-through drawing of the submersible probe

FIG. 13 is a close-up angled, cut-through drawing of the submersible probe showing the direction light travels from emitter to receiver.

### DETAILED DESCRIPTION OF THE INVENTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

The detailed description and drawings utilizes the following reference numerals in order to help describe the invention: 1—the top-vessel which water flows through; 2—an O-ring to create a water-tight seal; 3—a clear plastic “slide” which the photochemical sensor material and white-balance are attached to; 4—a light-guiding panel with holes cut to direct incoming and reflected light to their respective destinations while mitigating ambient light exposure; 5—a threaded attachment on top-vessel 1 to allow for easy attachment to existing piping; 6—a hexagonal region of top-vessel 1 allowing for convenient tightening on pipes on threaded attachment 5; 7—Vertical hole through light-guiding panel 4 for light to travel from light transmitter up through slide 3; 8—Angled hole through light-guiding panel to direct the returning reflected light to the light receiver; 9—Holes for securing top-vessel 1 to the slide 3 and light-guiding panel 4; 10—Photochemical sensor patches; 11—Porous membrane to protect patches from degrading in water and from biological interference while allowing water to flow through; 12—White-balance porous membrane (made of same material as porous membrane 11, but without photochemical sensor patch 10 underneath); 13—Expanded light-guiding panel that can also double as one side of the electronics enclosure; 14—Light transmitted onto photochemical sensor material 10 or white balance 12; 15—Light reflecting off of photochemical sensor material 10 or white balance 12 onto light receiver; 16—Top lid for submersible probe; 1—Potted bottom around PCB for submersible probe; 18—Wire attaching submersible probe to monitor; 19—Slits allowing water to flow over photochemical sensors patch 10 on submersible probe; 20—Holes for securing Lid 16 of submersible probe to Potted PCB board 17; 21—PCB board containing light emitter and receiver; 22—Light emitter; and 23—Light receiver.

The invention can consist of four main mechanical pieces that attach together to form a water-tight unit that sit flat upon an electronic board or be attached to independent light sources and receivers. These four pieces are top-vessel 1, O-ring 2, translucent slide 3, and light-guiding panel 4. These pieces are attached together using screw-holes 9, but can also be attached using adhesive. O-ring 2 fits into a groove in top-vessel 1 to form a water-tight seal between the top-vessel 1 and the slide 3. The entire apparatus can be attached to an existing piping system using threads 5 and hexagonal grip 6 on top-vessel 1 or can have water pumped through it using an external pump and tubing. Photochemical sensors 10 are secured under porous membranes 11 using a clear, double-sided adhesive. Light-guiding panel 4 sits underneath slide 3. The light source (can be an LED or other light emitting device) fits into vertical light-hole 7, and the light receiving device fits into angled light-hole 8. White-balance membrane 12 is placed on the slide without any photochemical patch underneath it.

With top-vessel 1 and slide 3 compressing O-ring 2 to form a watertight seal (either using screw holes 9 or an adhesive), and placed on top of light-guiding panel 4, the apparatus is either attached to the existing piping system using threads 5 and grip 6, or has water pumped through it using external equipment. As water passes through top-vessel 1, it also moves through porous membrane 11, soaking photochemical sensors 10. Photochemical sensors 10 can measure a number of parameters: pH, dissolved oxygen, ammonia, nitrates, nitrites, and others. To take readings, light 14 emits a constant light (in color and intensity) from a light source (likely an LED, but can be other) and shines up through vertical light-hole 7. It then passes through clear slide 3 (made from plastic or glass), causes a photochemical reaction in the respective photochemical sensor 10, and reflects return light 15, which travels down angled light-hole 8 to the light receiver. Light-guiding panel 4 has vertical holes 7 and angled holes 8 placed in such a way to eliminate any ambient light that could shine directly from the light emitter to the light receiver. Angled hole 8 is placed at a 45° angle allowing for a triangular light-stopping barrier between the light emitter and light receiver. This allows only light 15 and no ambient light to return to the light receiver. The light receiver can read attributes of return light 15 that include color, intensity, and duration. The light receiver then takes this raw data and delivers it to the units CPU for further processing and potentially transmission of the readings. This process is repeated for each photochemical sensor 10 over the course of a set period of time to retrieve regular readings.

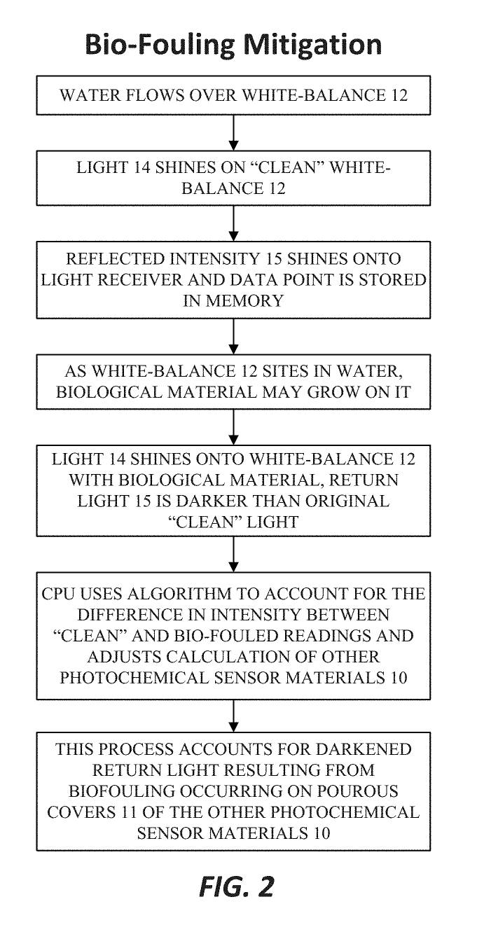

For how the invention addresses bio-fouling, see FIG. 2. The invention uses white-balance 12 to account for the buildup of biological matter onto porous membrane 11. To be clear, white balance 12 is made of the same material as porous membrane 11, I differentiate between them on the drawings for the purpose of describing the invention. The difference between white balance 12 and porous membrane 11 is that white balance 12 does not have a photochemical sensor in between it and slide 4. Without the photochemical sensor, the light reading device can detect changes in the intensity of light reflected directly off of white balance 12, which changes depending upon the buildup of biological material on the outside of the membrane. Such biological material could potentially alter the reading of return light 8 of photochemical sensors 10. Because the invention will often be used in water that is highly biologically active, the purpose of white-balance 12 is to reduce the time between necessary cleanings to remove this biological matter off of the sides of white membrane 11 that are exposed to the water. The CPU and computer memory that is used with the invention contains calibration information for white-balance 12, noting the color and intensity of return light 8 when white-balance 12 is clean and has no biological matter. To give an example, let us say the clear light reading when clean is 2,000. But as biological matter grows on the back-surface of white balance 12, return-light 8 will darken. In our example, let us say, the returning clear light falls to 1,800. As white-balance 12 gains more biological matter on its surface, it means that other porous membranes 11 have darkened as well, and their respective return-light 8's have also likely darkened. This phenomenon could potentially lead to incorrect readings, as the CPU could interpret such darkening as a legitimate change in the photochemical sensor, when it fact, it is an error due to bio-fouling. With an algorithm, the unit's CPU can contrast return-light 8's current readings coming from white-balance 12 (1,800 in our example) with those of the original settings (2,000 in our example), and adjust the calculations coming back from the photochemical sensors 10 (moving them down by 200) to account for the darkening effect of biological material. Because biological material grows on porous membrane 11 evenly, the CPU can use a linear correlation when taking the light differences from a clean white balance 12 to a bio-fouled one and apply it to the readings of photochemical sensor 10. Note that white balance 12 can use multiple aspects of incoming light to achieve its goals. As stated in the example above, it can use clear light, or it can focus on changes in just one of the base colors: red, green, or blue. These later calculations can also use a linear calibration, but other equations can be used depending upon the nature of the photochemical sensor. Thus, through the white balance method, the unit is able to electronically account for the buildup of biological material and can increase the amount of time the device can continue deliver accurate readings, even in highly biological environments.

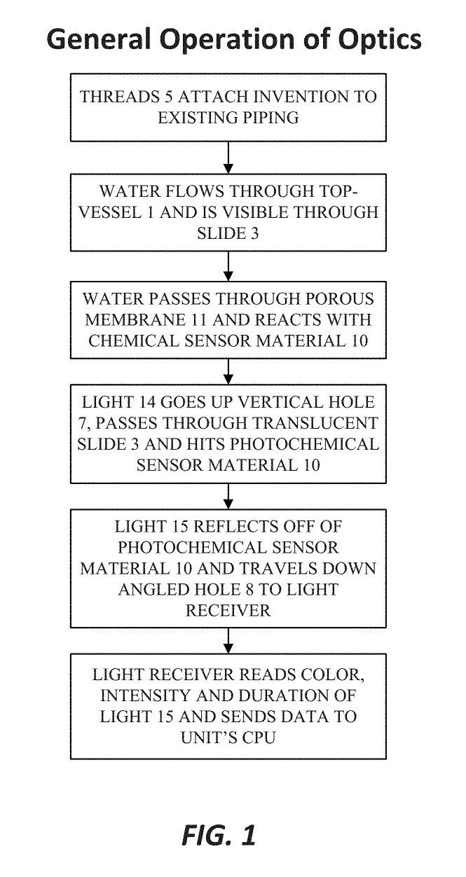

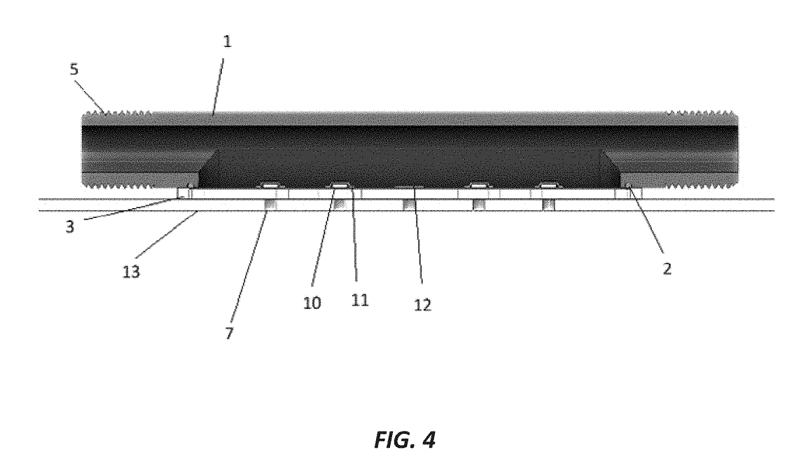

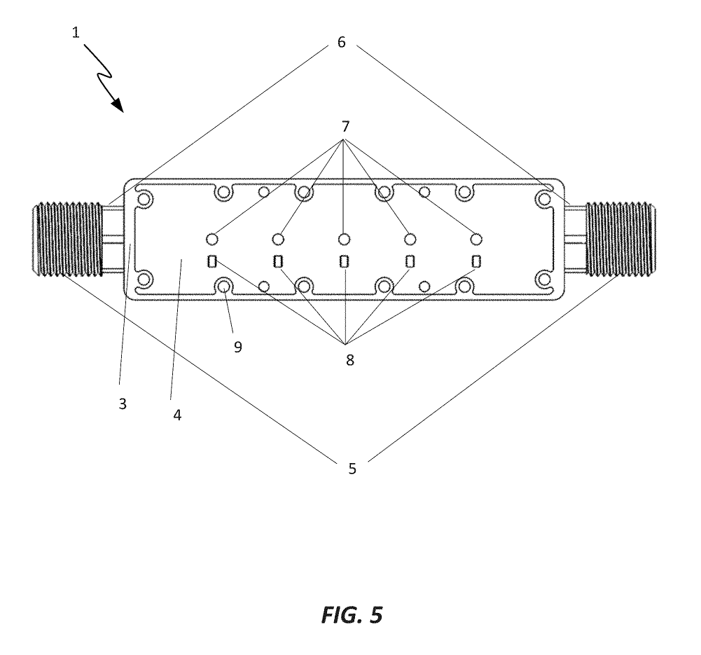

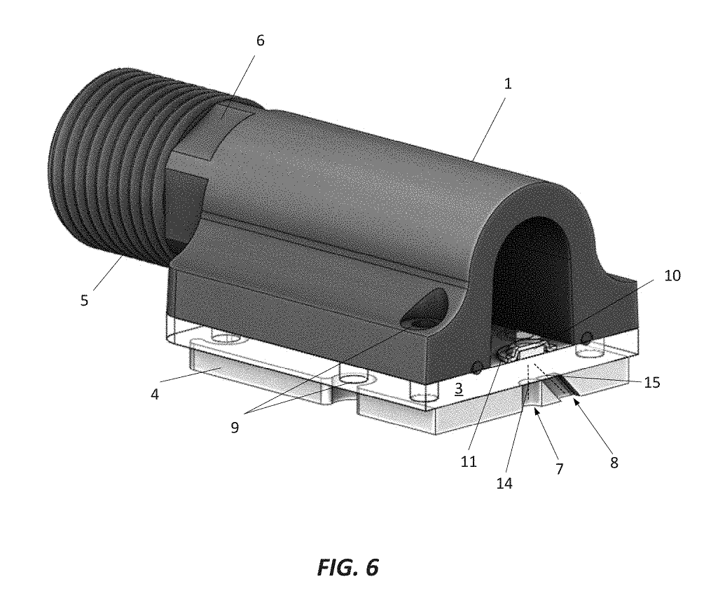

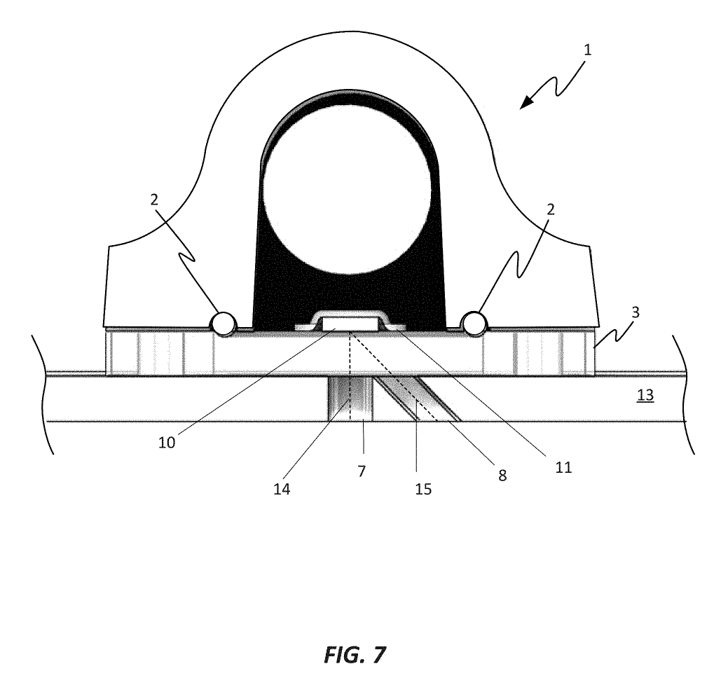

The invention is not limited to the numbers of photochemical sensors 10, holes 7 and 8, and porous membranes shown in FIGS. 1-8. In these drawings, the invention has only five vertical 7 and angled 8 holes to take readings of photochemical sensors 10. If more photochemical sensors are required, the top-vessel 1, slide 3, and light-guiding panel 4 can be elongated in their construction to accommodate as many photochemical sensors as needed.

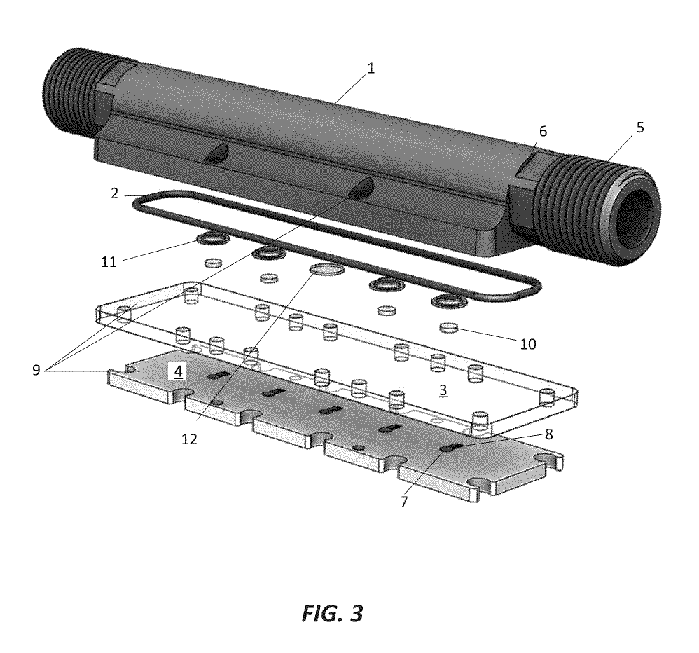

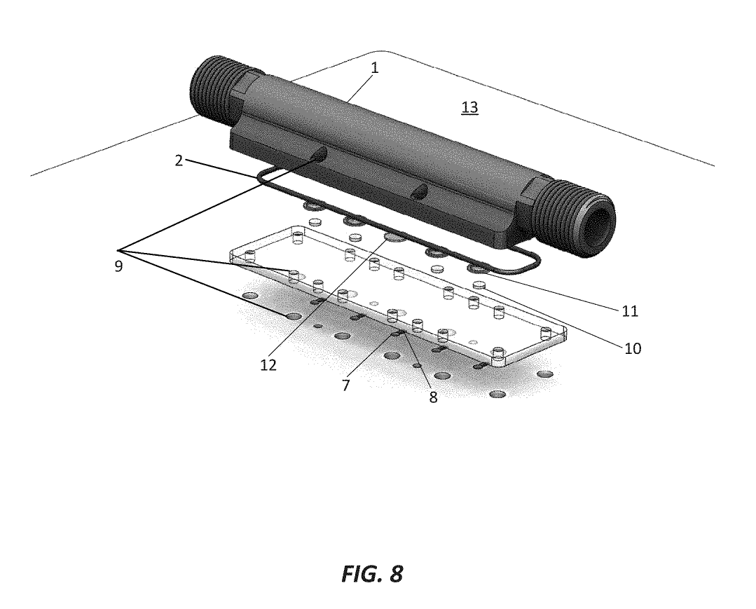

Additionally, the invention is not limited in its application of light-guiding panel 4. See FIG. 8. The size of light-guiding panel 4 is not limited to the size in FIGS. 3-7. It can be expanded to cover more area and may be fully incorporated into the enclosure that houses the electronics board itself, thus eliminating it as an independent piece.

Finally, the method for attaching slide 3 to top-vessel 1 and both of them to light-guiding panel 4 can be accomplished not just with screws and O-ring 2, but with adhesive, or other mechanical locking techniques.

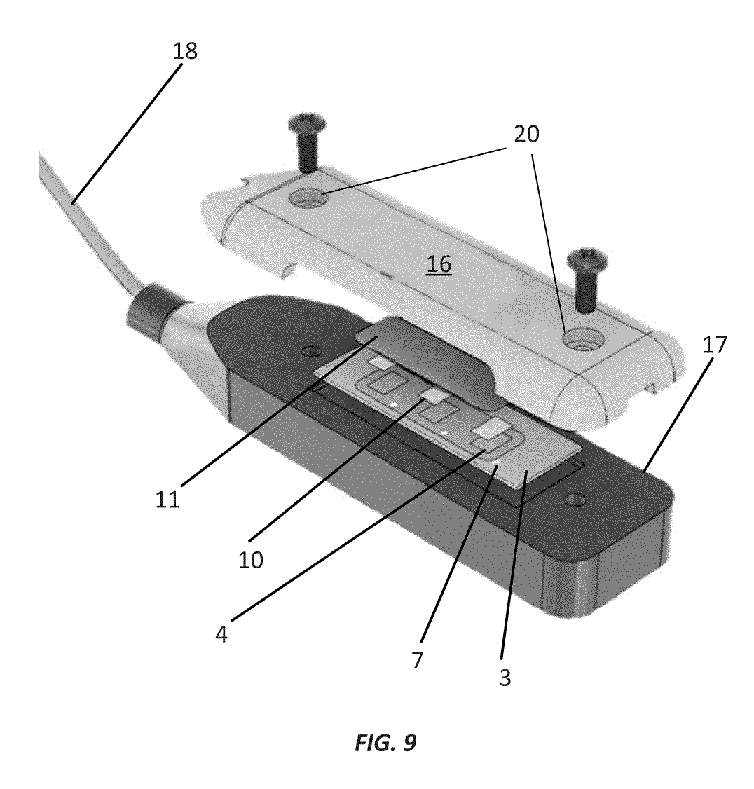

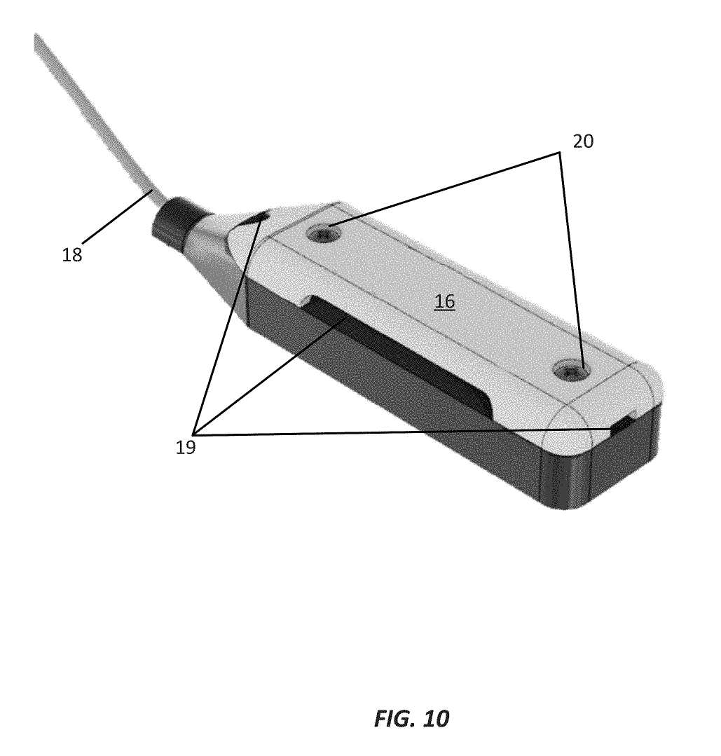

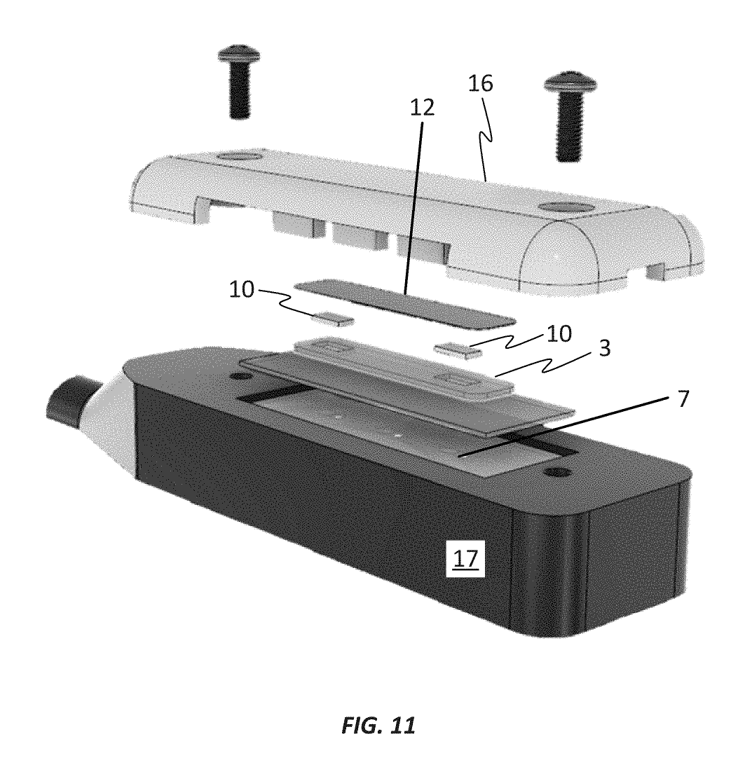

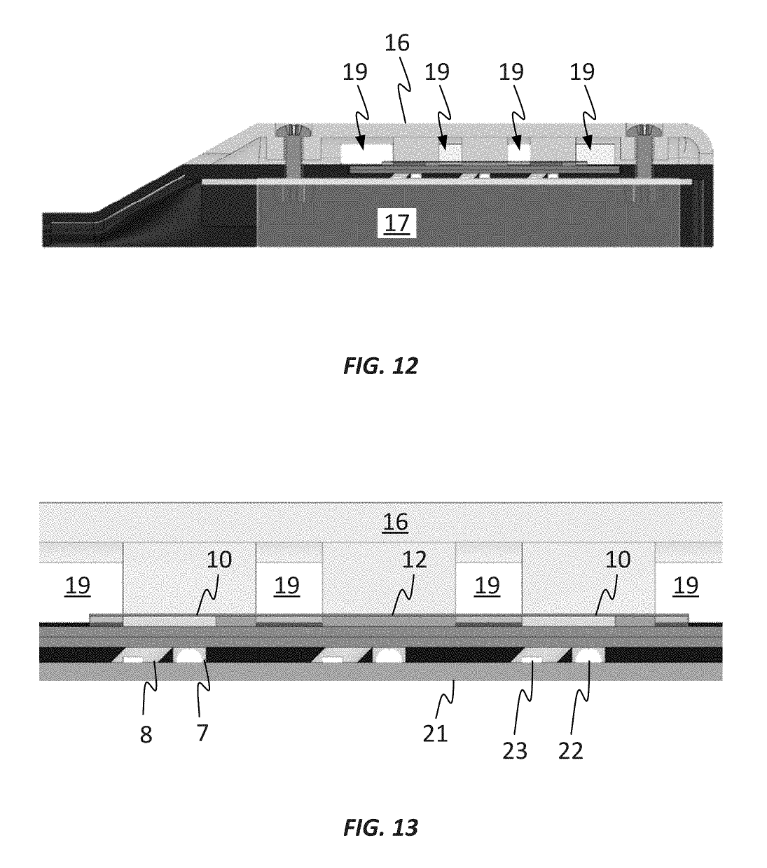

The invention can also be enclosed in a submersible probe and plugged remotely into a monitoring system using wire 18 as depicted in FIGS. 9-13 . In this use case, water flows under lid 16 and through slits 19, over porous membrane 11, and onto photochemical sensor patches 10. PCB board 21 is potted in bottom 17 with light guiding panel 4 sitting on top. This configuration allows light 14 to travel through light guiding panel 4, through slide 3, and reflect back down angled hole 8, while keeping the PCB board safe from water damage as it is submerged in a tank of water. In the same configuration as the above embodiments of the invention, light guiding panel 4 directs light 14 up vertical hole 7 from the PCB potted in bottom 17 which reflects off of photochemical sensor patch 10 and down angled hole 8 (as shown in FIG. 13). The light is then assessed using the same processes as the other variations of the invention and the data is transmitted to the CPU using wire 18. The purpose of this variation of the invention is to eliminate the need to have water flow through a monitor, but instead, allow users to mount a monitor in a convenient location and place the submersible probe into the water they wish to monitor. As seen in FIG. 11, the submersible version of the invention can also utilize the “white balance” method of adjusting for biofouling of porous membrane 11.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. An optical measuring device, comprising:
a housing defining a channel therethrough;
a plurality of photochemical sensors disposed along an interior surface of the housing that defines at least a portion of the channel;
a calibration sensor disposed along the interior surface;
a light emitting system configured to emit light at the photochemical sensors and the calibration sensor;
a light detecting system configured to measure the intensity of the light reflected off each of the plurality of photochemical sensors and the intensity of light reflected off the calibration sensor; and
a processor configured to receive intensity measurements from the light detecting system, calibrate the intensity measurements associated with the plurality of photochemical sensors using the intensity measurements associated with the calibration sensor and determine one or more characteristics of aqueous solution flowing through the channel using the calibrated intensity measurements.

2. The optical measuring device of claim 1, wherein the housing comprises a translucent slide secured to the housing.

3. The optical measuring device of claim 2, wherein the plurality of photochemical sensors are distributed along an interior facing surface of the translucent slide.

4. The optical measuring device of claim 3, further comprising:
a light-guiding panel coupled to an exterior facing surface of the translucent slide, the light-guiding panel defining openings that allow light from the light emitting system to pass through the translucent slide and reflect off the plurality of photochemical sensors and back to the light detecting system.

5. The optical measuring device of claim 4, wherein the light emitting system comprises a light emitter configured to emit light through a vertical hole extending through the light-guiding panel.

6. The optical measuring device of claim 5, wherein the light receiving system comprises an optical sensor configured to receive light emitted from the light emitter through an angled hole defined by the light-guiding panel.

7. The optical measuring device of claim 1, wherein the housing includes a threaded attachment system for attachment of the optical measuring device to a piping system.

8. An optical measuring device, comprising:
a housing defining a cavity;
a lid coupled to the housing and extending across an opening leading into the cavity, the lid defining a plurality of slits that are configured to allow water to flow between the housing and the lid;
a photochemical sensor disposed within the cavity;
a light emitter configured to emit light at the photochemical sensor; and
an optical sensor configured to measure the intensity of the light reflected off the photochemical sensor; and
a processor configured to receive intensity measurements from the optical sensor of the light reflected off the photochemical sensor and determine one or more characteristics of aqueous solution flowing through the slits using the calibrated intensity measurements.

9. The optical measuring device of claim 8, further comprising a plurality of fasteners securing the lid to the housing.

10. The optical measuring device of claim 8, further comprising:
a printed circuit board,
wherein the optical sensor and the light emitter are coupled to a first surface of the printed circuit board.

11. The optical measuring device of claim 8, further comprising a light-guiding member disposed between the printed circuit board and the photochemical sensor and defining openings directing the transmission of light between the light emitter the photochemical sensor and the optical sensor.
